(19) United States
(12) Patent Application Publication
(10) Pub. No.: US 2017/0195702 A1
(43) Pub. Date: Jul. 6, 2017

(54) MONETIZING TELEVISED CONTENT BASED ON USER ACTIVITY

(71) Applicant: PayPal Inc., San Jose, CA (US)

(72) Inventors: Ananya Das, Austin, TX (US); Bryant Genepang Luk, Round Rock, TX (US); Christopher Diebold O'Toole, Cedar Park, TX (US)

(21) Appl. No.: 14/985,061

(22) Filed: Dec. 30, 2015

(51) Int. Cl. H04N 21/2543; H04N 21/45; H04N 21/258; H04N 21/234; H04N 21/81

(52) U.S. Cl. CPC H04N 21/2543; H04N 21/23424; H04N 21/812; H04N 21/25883; H04N 21/4532

(57) ABSTRACT

A method of monetizing televised content based on user activity is described. The method may include providing an option to alter an original televised event in exchange for a performance of an activity. The method may also include receiving a user selection of the option to alter the original televised event, a user selection of the activity, and an agreement of the user to perform the activity. The method may include causing a modification to the original televised event to create an altered televised event based on the option. The method may also include determining that the activity has at least partially been performed. The method may include providing the altered televised event.

### FIELD

The embodiments discussed herein are related to monetizing televised content based on user activity.

### BACKGROUND

To help sell their goods and/or services, merchants often use television advertisements. The merchants either create the advertisements or they may hire a third party to create the advertisements. The merchants may provide the advertisements to a television broadcaster for display on a consumer's television.

The subject matter claimed herein is not limited to embodiments that solve any disadvantages or that operate only in environments such as those described above. Rather, this background is only provided to illustrate one example technology area where some embodiments described herein may be practiced. Further, unless otherwise indicated, the materials described in the background section are not prior art to the claims in the present application and are not admitted to be prior art by inclusion in this section.

### SUMMARY

According to an aspect of an embodiment, a method to monetize televised content based on user activity may include providing an option to alter an original televised event in exchange for a performance of an activity. The method may also include receiving a user selection of the option to alter the original televised event, a user selection of the activity, and an agreement of the user to perform the activity. The method may include causing a modification to the original televised event to create an altered televised event based on the option. The method may also include determining that the activity has at least partially been performed. The method may include providing the altered televised event.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example operating environment in which some embodiments may be implemented;

FIG. 2 illustrates a flow diagram of an example method of monetizing televised content based on user activity that may be implemented in the operating environment of FIG. 1;

FIG. 3 illustrates a flow diagram of another example method of monetizing televised content based on user activity; and

FIG. 4 illustrates a diagrammatic representation of a machine in an example form of a computing device within which a set of instructions, for causing the machine to perform any one or more of the methods discussed herein, may be executed.

### DESCRIPTION OF EMBODIMENTS

Merchants may advertise to consumers through television advertisements. The television advertisements may be presented periodically during a scheduled television program. Typically, a predetermined duration of time in the scheduled television program is reserved for television advertisements. Television viewers (hereafter referred to as “user” or “users”) often have little control over how or when television advertisements are presented with conventional television broadcasting. Some televised content (or on-demand content) may be provided on a pay-per-view basis. Similar to conventional television broadcasting, users also may have little control over the pay-per-view nature of the televised content. For example, a user may not desire to pay a full price for a pay-per-view event. But, the user may be willing to pay less than the full price in exchange for performing a predefined activity, such as viewing additional advertisements, completing a purchase of an item, etc. The systems and methods described herein may provide users with more input on how they may consume commercialized televised content. Commercialized televised content may include content with advertisements and pay-per-view content (with or without advertisements). Commercialized televised content may be referred to herein as “video content.”

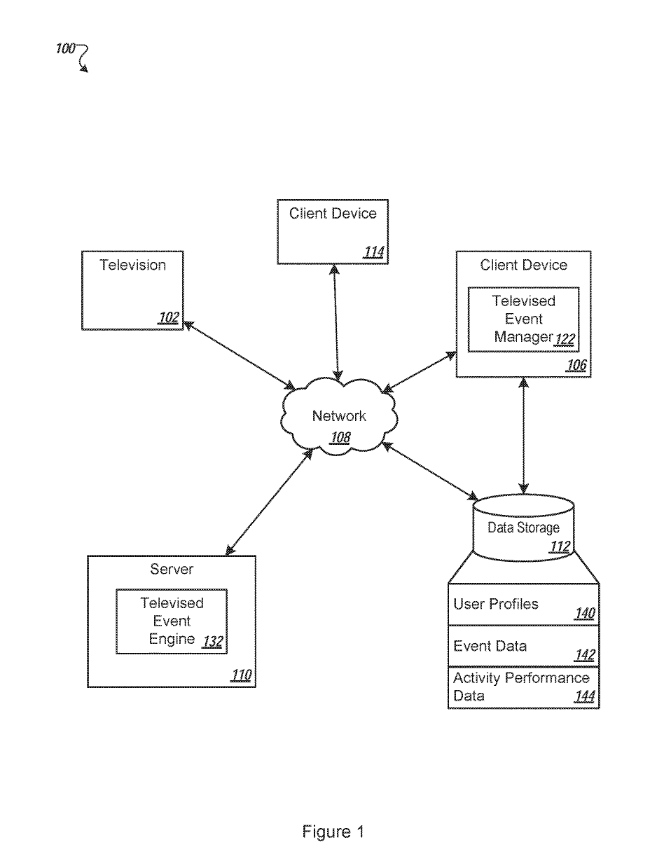

FIG. 1 illustrates a block diagram of an example operating environment 100 in which some embodiments may be implemented, arranged in accordance with at least one embodiment described herein. The example operating environment 100 may include a television 102, a client device 106, a network 108, a server 110 and a data storage 112.

The television 102 may include a device that is configured to present video content via a display device. The video content may include an audio component that plays simultaneously with the video content. For ease in explanation, “video content” may refer to a combination of video and audio content. Video content of a finite duration may be referred to as a “televised event.” The video content may include an electronic file that may be executed or loaded using software, firmware or hardware configured to present the content to a user via the television 102. Video content may also include live-streamed content and media items available on-demand and pay-per-view. The television 102 may receive the video content from any source, such as from an over-the-air broadcaster, satellite, cable, a media server (e.g., server 110), a streaming device (e.g., from the client device 106), or from any other source capable of sending video content to the television 102. The video content may include (or be supplemented with) one or more electronic advertisements. The electronic advertisements may advertise any product or service and may be received from any source. In at least one embodiment, to play an advertisement, the television 102 may stop playback of video content and play the advertisement. Once presentation of the advertisement is complete, the television 102 may resume playback of the video content.

In at least one embodiment, the example operating environment 100 may include a set-top box (STB) (not illustrated). The STB may include a device that is configured to convert video content to analog or digital TV signals. In at least one embodiment, the STB includes a satellite TV receiver or an over-the-air digital-to-analog converter. In at least one other embodiment, the STB may include a media hub that connects to a local network for Internet access and may convert video from online media providers (e.g., Netflix, Hulu) into TV signals. The STB may also connect to and receive content from the client device 106. The STB may send analog or digital TV signals to the television 102 for playback. In at least one embodiment the STB is integrated with the television 102.

The client device 106 may include a computing device which may include, but is not limited to, a desktop computer, a laptop computer, a tablet computer, a mobile phone, a smartphone, a personal digital assistant (PDA), or other suitable computing device. The client device 106 may include any number of applications that may enable a user to perform various tasks. The applications may also include various advertisement and activity tracking components. In at least one embodiment, the client device 106 may include one or more sensors, receivers and/or transceivers (not illustrated) that may be configured to detect activities. The sensors, receivers and/or transceivers may include an audio sensor (e.g., a microphone), a wireless digital signal transceiver (e.g., Wi-Fi, Bluetooth, ZigBee, Z-Wave), a motion sensor (e.g., gyroscope, accelerometer, GPS unit), and the like.

In general, the network 108 may include one or more wide area networks (WANs) and/or local area networks (LANs) that enable the television 102, client device 106, server 110, and data storage 112 to communicate with each other. In some embodiments, the network 108 includes the Internet, including a global internetwork formed by logical and physical connections between multiple WANs and/or LANs. Alternately or additionally, the network 108 may include one or more cellular RF networks and/or one or more wired and/or wireless networks such as, but not limited to, 802.xx networks, Bluetooth access points, wireless access points, Long Term Evolution (LTE) or LTE-Advanced networks, IP-based networks, or the like. The network 108 may also include servers that enable one type of network to interface with another type of network.

The example operating environment 100 may include any number of servers 110. The server 110 may include one or more computing devices, (such as a rackmount server, a router computer, a server computer, a personal computer, a mainframe computer, a laptop computer, a web server, a proxy server, a desktop computer, etc.), data stores (e.g., hard disks, memories, databases), networks, software components, and/or hardware components. The server 110 may provide video content (e.g., digital video, streaming video) to the television 102. To provide video content, for example, the server 110 may determine whether a user is permitted to access content selected by the user (e.g., whether the user is a subscriber). The server 110 may also provide advertisements to the television 102.

In at least one embodiment, the data storage 112 may include a memory (e.g., random access memory), a cache, a drive (e.g., a hard drive), a flash drive, a database system, or another type of component or device capable of storing data. The data storage 112 may also include multiple storage components (e.g., multiple drives or multiple databases) that may span multiple computing devices (e.g., multiple server computers). The data storage 112 may store one or more user profiles 140 that include advertisement information about a user. The data storage 112 may include information related to televised events (e.g., content data, options, activities) to which the user has registered, information related to activities that the user may perform in relation to a televised event, which collectively may be stored in data storage 112 as event data 142. The data storage 112 may also store activity performance data 144. Although each of the client device 106 and data storage 112 are depicted in FIG. 1 as single, disparate components, these components may be implemented together in a single device or networked in various combinations of multiple different devices that operate together.

The server 110 may include a televised event engine 132. The televised event engine 132 may create and modify televised events according to user profiles 140, event data 142 and activity performance data 144. The televised event engine 132 may also define available televised events, options for altering the televised events, activities that may be performed in order to alter the televised events, etc. In at least one embodiment, a system administrator may input the options for altering the televised events and the activities that may be performed in order to alter the televised events. For example, the televised event engine 132 may define a televised pay-per-view event that may include an option to reduce the price of the pay-per-view event in exchange for an activity that includes user interacting (e.g., viewing, making purchases) with advertisement material.

The options for altering the televised events may include any advertising or promotional scheme. Examples of advertisement-based options may include reducing a number or a total duration of advertisements to be presented during the televised event, delaying the presentation of advertisements, a reduction in a number of commercial breaks of the televised event, an addition or substitution of at least one product placement advertisement to the televised event, a substitution of a variation of a product (such as a blue vs. red or complex vs. simple version of a product), which may be based on user preference, etc. Selectable options may be stored as event data 142 in the data storage 112.

The activities that may be performed in order to alter the televised events may include an activity before, during, or after the televised event, or a combination thereof. In at least one embodiment, activities may be cumulative, where additional subsequently performed activities may further reduce advertising or a cost associated with the televised event. Example activities may include a consumer activity (e.g., browsing webpages, viewing advertisements, making a purchase of an item or an item from a group of items), a social activity (e.g., posting a social message online, liking a page or post, sharing or resharing a social post), a movement activity (e.g., an activity related to user travel or fitness), a group activity, etc. In at least one embodiment, if a group of users are engaged in a promotional scheme, then an advertisement may be turned into a multi-player game that may promote a product. For example a team-based block breaking game that helps a promoted car escape an obstacle, or if all participants agree to wear a virtual reality headset at the same time, then the group promotional scheme may include a shared simulated test drive of the car. The activities that may be performed in order to alter the televised events may be performed at any time, such as before, during or after the televised event. Some activities may not be available for some options. Selectable activities may be stored as event data 142 in the data storage 112. Further, a record of a user performance in relation to a televised event may be stored as activity performance data 144 in the data storage 112.

To create a televised event, the televised event engine 132 may associate content, one or more options alter the televised event, one or more activates that may be performed by a user or a group of users to activate the one or more options. The televised event engine 132 may send the televised event to the televised event manager 122. In at least one embodiment, the televised event engine 132 may send information related to the televised event to the televised event manager 122 without sending the actual content of the televised event. The televised event manager 122 may present the information related to the televised pay-per-view event to the user, such as via a list of available events along with their associated options and activities.

The client device 106 may include the televised event manager 122. The televised event manager 122 may include an application (or part of an application) on the client device 106. For example, the application may include a web browser that may present a list of available televised events to the end user. As a web browser, the application may also access, retrieve, present, and/or navigate content (e.g., web pages such as Hyper Text Markup Language (HTML) pages, digital media items, etc.) served by a web server. The application may render, display, and/or present the list content to the user. The application may also provide an embedded media player (e.g., a Flash® player or an HTML5 player) that is embedded in a web page (e.g., a web page that may provide information about available televised events). In another example, the application may include a standalone application (e.g., a mobile application or mobile app) that allows users to consume digital media items (e.g., digital videos, digital images, electronic books, websites, etc.). The application may be provided to the client device 106 by the server 110 or via an application store.

The televised event manager 122 may provide information to the user (such as via a graphical user interface (GUI)) that relates to available televised events, options for altering the televised events, activities that may be performed in order to alter the televised events, etc. The televised event manager 120 may also monitor for performance of the activities.

Using an interface provided by the televised event manager 122, the user may select a televised event, one or more options for altering the televised event, and one or more activities that may be performed in order to alter the televised event. Once selected, the televised event, the one or more options for altering the televised event, and the one or more activities may be stored in the data storage 112 as event data 142. The televised event manager 120 may receive the event data 142 from the user and send the event data 142 to the televised event engine 132 on the server 110. The televised event manager 122 may also send an identifier of the user (e.g., a user profile 140) or an identifier of the client device 106 (e.g., a MAC address, UUID) to the televised event engine 132. In at least one embodiment, the televised event manager 122 may use the event data 142 to request that the televised event engine 132 provide content to the client device 106 or to the television 102 according to the parameters of the event data 142.

In response to receiving a selection of an available event with the selected options and activities, the televised event engine 132 may coordinate a broadcast of the event. In at least one embodiment, the televised event manager 122 causes the televised event engine 132 to coordinate a broadcast of the televised event, such as by sending instructions to the televised event engine 132 on the time, location, broadcasting device, etc. related to the selected event. The televised event may be presented on the television 102, the client device 106, the client device 114, or a combination thereof.

The televised event manager 122 may also monitor for performance of the activities that are part of the televised event. The televised event manager 122 may identify performance of activities pertaining to the televised event before, during and/or after the selected event. In at least one embodiment, the televised event manager 122 may monitor other applications and activities of the user on the user device 106 to identify performance of activities pertaining to the televised event. In at least one embodiment, a user may indicate a relationship of an activity (e.g., a purchase) to a televised event.

For activities that are to be performed prior to the televised event, the televised event manager 122 may monitor for such performance. For example, an activity may include watching a predetermined number of advertisements prior to the televised event. The televised event manager 122 may provide a platform to the user to watch the predetermined number of advertisements prior to the televised event. The televised event manager 122 may record the performance of the activity as activity performance data 144, which the televised event manager 122 may reference prior to permitting the user to consume the televised event. In at least one embodiment, the televised event may include multiple activities that are to be performed prior to the televised event. When all of the multiple activities have not been performed, the televised event manager 122 may prevent access to, or halt the broadcast of the televised event. In at least one other embodiment, when all of the multiple activities have not been performed, the televised event manager 122 may provide limited access to the televised event. The limited access may include providing access to the televised event for less time than a total run time of the televised event. The limited access may also include removing some but not all of the advertisements from the televised event.

For activities that are to be performed during the televised event, the televised event manager 122 may monitor for such performance. The televised event manager 122 may continuously or periodically monitor any action of the one or more users (e.g., client devices 106, 114) for performance of the activities. For example, a selected option may include removing ads from the televised event and the activity may include the user allowing televised event manager 122 to limit access to the client device 106 during some or all of the televised event. For example, the televised event manager 122 may only permit certain applications on the client device 106 to function during the televised event. The televised event manager 122 may impose a restriction of at least a portion of the user device 106 during at least a portion of the televised event. Further, televised event manager 122 may limit the functionality of some applications on the client device 106 during the televised event, such as only allowing Internet access to certain websites during the televised event.

In at least one embodiment, the televised event manager 122 may dynamically alter the televised event during the televised event. For example, when an activity includes an agreement to watch a predetermined number of advertisements during the event, and a user watches a number of advertisements that exceeds that predetermined number, the televised event manager 122 may provide a reward to the user, such as further reducing a number of advertisements to be presented during the televised event, lowering a cost of the televised event, providing a promotion, etc.

For activities that are to be performed after the televised event, the televised event manager 122 may monitor for such performance, such as for a predetermined amount of time after the completion of the televised event. For example, a user may agree to perform some or all of the activities after the completion of the televised event. If the televised event manager 122 does not receive an indication of performance of the activity, the televised event manager 122 may add a cost to the televised event and/or may increase a number of advertisements to present during the remainder of the televised event.

In a specific example, the televised event engine 132 may define a televised pay-per-view event that may include an option to reduce the price of the pay-per-view event in exchange for an activity that includes user interacting (e.g., viewing, making purchases) with advertisement material. The televised event engine 132 may send information relating to the televised pay-per-view event to the televised event manager 122. The user may select the televised pay-per-view event for viewing on the television 102 (or on a display on the client device 106). In at least one embodiment, the televised event engine 132 may send information related to the televised pay-per-view event to the televised event manager 122 without sending the actual content of the televised pay-per-view event. The televised event manager 122 may present the information related to the televised pay-per-view event to the user, such as via a list of available events. Once the user selects the televised event or performs the selected activities, the televised event engine 132 may the content associated with the televised pay-per-view event to the televised event manager 122, to the television 102, and/or to the client device 106.

Modifications, additions, or omissions may be made to the example operating environment 100 without departing from the scope of the present disclosure. Specifically, embodiments of the example operating environment 100 are depicted in FIG. 1 as including one television 102, one network 108, one server 110 and one data storage 112. However, the present disclosure applies to an example operating environment 100 including one or more televisions 102, one or more client devices 106, 114, one or more networks 108, one or more servers 110 and one or more data storages 112, or any combination thereof.

Moreover, the separation of various components in the embodiments described herein is not meant to indicate that the separation occurs in all embodiments. Additionally, it may be understood with the benefit of this disclosure that the described components may be integrated together in a single component or separated into multiple components.

In situations in which the systems discussed here collect personal information about users, or may make use of personal information, the users may be provided with an opportunity to control whether the systems discussed collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information may be determined for the user, or a user's geographic location may be generalized where location information is obtained (such as to a city, ZIP code, or state level), so that a particular location of a user may not be determined. Thus, the user may have control over how information is collected about the user and used by the systems discussed.

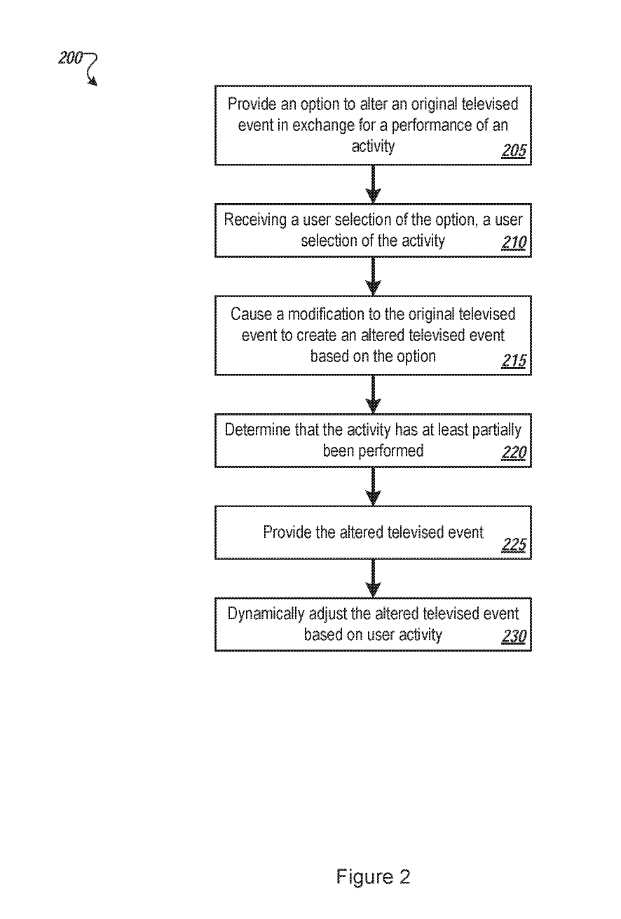

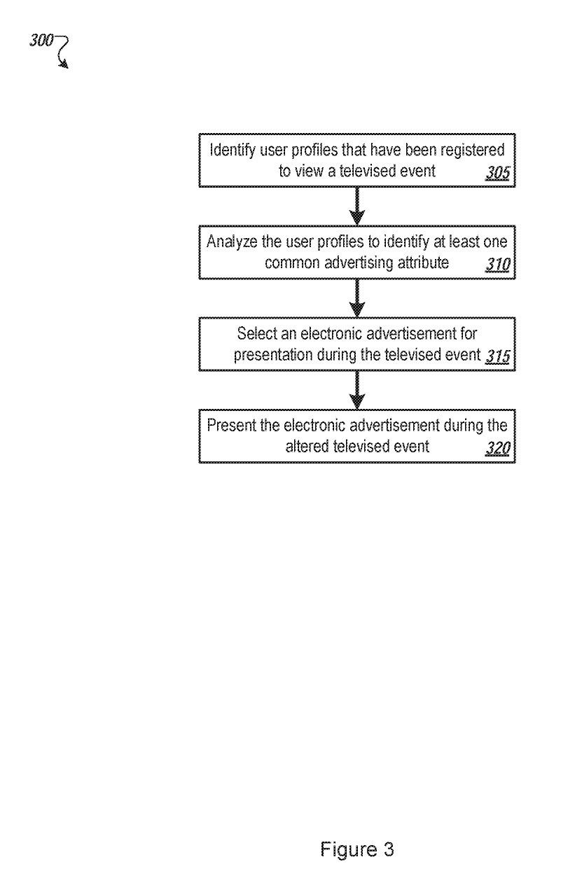

FIGS. 2-3 illustrate flow diagrams of various methods related to monetizing televised content based on user activity. The methods may be performed by processing logic that may include hardware (circuitry, dedicated logic, etc.), software (such as is run on a general purpose computer system or a dedicated machine), or a combination of both, which processing logic may be included in the television 102, the client device 106, the server 110, client device 114, or another computer system or device. For simplicity of explanation, methods described herein are depicted and described as a series of acts. However, acts in accordance with this disclosure may occur in various orders and/or concurrently, and with other acts not presented and described herein. Further, not all illustrated acts may be required to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 2 illustrates an example flow diagram of a method 200 of monetizing televised content based on user activity that may be implemented in the operating environment of FIG. 1, arranged in accordance with at least one embodiment described in the present disclosure.

The method 200 may begin at block 205, where processing logic may provide an option to alter an original televised event in exchange for a performance of an activity, as further described in conjunction with FIG. 1. At block 210, the processing logic may receive a user selection of the option to alter the original televised event, a user selection of the activity, and an agreement of the user to perform the activity, as further described in conjunction with FIG. 1.

At block 215, the processing logic may cause a modification to the original televised event to create an altered televised event based on the option. In at least one embodiment, causing the modification to the original televised event may include adding or causing a product placement advertisement to be added to the original televised event. In at least one embodiment, the processing logic may add (or cause to be added) one or more markers to the original televised event. The markers may be added so as to draw attention to the product placement advertisement. For example, a marker may include an icon (e.g., an arrow) and/or text to help a user better see the product placement advertisement on a screen. In at least one embodiment, the original televised event may include one or more slots to place product placement advertisements. Performing a modification to the original televised event may include identifying a product placement advertisement and adding that product placement advertisement to the slot in the original televised event. In at least one embodiment, the product placement advertisement may be targeted to a one or more users based on user profile(s).

At block 220, the processing logic may determine that the activity has at least partially been performed. In at least one embodiment, the processing logic may receive a notification that the user has interacted with an advertisement before, during or after the altered televised event. In at least one embodiment, the user may send the notification to the processing logic, such as via a client device or an application on the client device. In at least one embodiment, the notification may include information that the user has made a purchase before, during, or after a presentation of the original or altered televised event.

At block 225, the processing logic may provide the altered televised event, as further described in conjunction with FIG. 1.

At block 230, the processing logic may dynamically adjust the altered televised event based on user activity. In at least one embodiment, when the processing logic receives a notification that the user (or another user who is watching) made a purchase during a presentation of the original or altered televised event at block 220, the processing logic may modify the altered televised event, such as by removing an advertisement and/or reducing a cost of the altered televised event.

In at least one embodiment, the processing logic may dynamically adjust an original televised event based on user activity. In at least one embodiment, when the processing logic receives a notification that the user (or another user who is watching) made a purchase during a presentation of the original televised event at block 220, the processing logic may modify the original televised event to create the altered event, such as by removing an advertisement and/or reducing a cost of the original televised event.

For this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

FIG. 3 illustrates an example flow diagram of another method 300 of monetizing televised content based on user activity. At block 305, the processing logic may identify multiple user profiles that have been registered to view a televised event in a group. For example, when a first user is selecting an option to alter the original televised event in exchange for performance of an activity, the first user may select other users who may participate in the activity in conjunction with the televised event. The first user may send invitations to those other users, who may elect to participate in the activity. Those other users may register for the televised event. In at least one embodiment, each of those other users may not need to perform the activity, so long as the conditions of the activity have been met. For example, an activity may include making purchases that meet or exceed a minimum purchase value threshold. One or more (and less than all) of the users registered to the televised event may make purchases that in the aggregate may meet or exceed a minimum purchase value threshold.

At block 310, the processing logic may analyze the user profiles to identify at least one common advertising attribute. The common advertising attribute may include any action taken by any of the users, as recorded to their respective user profile. The processing logic may use the common advertising attribute to better target advertisements to the users who are associated with the multiple user profiles. For example, the processing logic may identify that a majority of the users have recently purchased a new coffee machine and all of the users are interested in tennis.

At block 315, the processing logic may select an electronic advertisement for presentation during the altered televised event based on the at least one common advertising attribute. For example, the at least one common advertising attribute may be information that all of the users are interested in tennis. Since a majority of the users have recently purchased a new coffee machine, the processing logic may determine that, because of the common interest in tennis, the minority of users may also be interested in the coffee machine. Thus, the processing logic may select a coffee machine advertisement for presentation during the altered televised event. At block 320, the processing logic may present the electronic advertisement during the altered televised event, such as on a television or a client device.

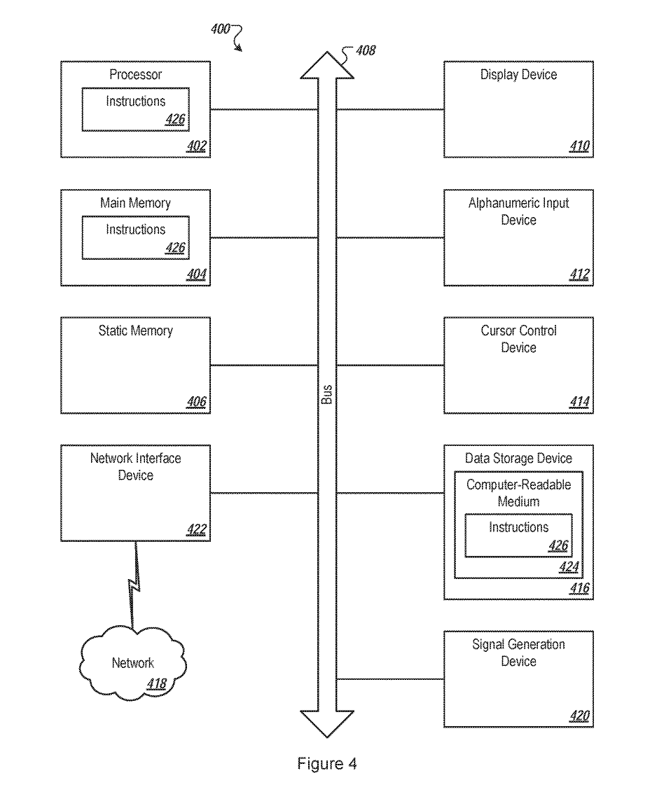

FIG. 4 illustrates a diagrammatic representation of a machine in the example form of a computing device 400 within which a set of instructions, for causing the machine to perform any one or more of the methods discussed herein, may be executed. The computing device 400 may include a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methods discussed herein, may be executed. In alternative embodiments, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 400 includes a processing device (e.g., a processor) 402, a main memory 404 (e.g., read-only memory (ROM), flash memory, dynamic random access memory (DRAM) such as synchronous DRAM (SDRAM)), a static memory 406 (e.g., flash memory, static random access memory (SRAM)) and a data storage device 416, which communicate with each other via a bus 408.

Processing device 402 represents one or more general-purpose processing devices such as a microprocessor, central processing unit, or the like. More particularly, the processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 may also include one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein.

The computing device 400 may further include a network interface device 422 which may communicate with a network 418. The computing device 400 also may include a display device 410 (e.g., a liquid crystal display (LCD) or a cathode ray tube (CRT)), an alphanumeric input device 412 (e.g., a keyboard), a cursor control device 414 (e.g., a mouse) and a signal generation device 420 (e.g., a speaker). In one implementation, the display device 410, the alphanumeric input device 412, and the cursor control device 414 may be combined into a single component or device (e.g., an LCD touch screen).

The data storage device 416 may include a computer-readable storage medium 424 on which is stored one or more sets of instructions 426 embodying any one or more of the methods or functions described herein. The instructions 426 may also reside, completely or at least partially, within the main memory 404 and/or within the processing device 402 during execution thereof by the computing device 400, the main memory 404 and the processing device 402 also constituting computer-readable media. The instructions may further be transmitted or received over a network 418 via the network interface device 422.

While the computer-readable storage medium 426 is shown in an example embodiment to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used herein and especially in the appended claims (e.g., bodies of the appended claims) are generally intended as “open” terms (e.g., the term “including” may be interpreted as “including, but not limited to,” the term “having” may be interpreted as “having at least,” the term “includes” may be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases may not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” may be interpreted to mean “at least one” or “one or more”); the same holds true for the use of definite articles used to introduce claim recitations.

In addition, even if a specific number of an introduced claim recitation is explicitly recited, those skilled in the art will recognize that such recitation may be interpreted to mean at least the recited number (e.g., the bare recitation of “two recitations,” without other modifiers, means at least two recitations, or two or more recitations). Further, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, may be understood to contemplate the possibilities of including one of the terms, either of the terms, or both terms. For example, the phrase “A or B” may be understood to include the possibilities of “A” or “B” or “A and B.”

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it may be understood that the various changes, substitutions, and alterations may be made hereto without departing from the spirit and scope of the present disclosure.

1. A method comprising:
providing an option to alter an original televised event in exchange for a performance of an activity, wherein the activity includes two or more activities selected from a group of activities consisting of: paying a fee to alter the original televised event, consuming an advertisement, and making a purchase;
receiving a user selection of the option to alter the original televised event, a user selection of the activity, and an agreement of the user to perform the activity;
causing, by a processing device, a modification to the original televised event to create an altered televised event based on the option;
determining, by the processing device, that the activity has at least partially been performed; and
providing the altered televised event.

2. The method of claim 1, wherein the option to alter the original televised event comprises:
an alteration to a set of advertisements associated with the original televised event; or
an alteration of a price associated with the original televised event.

3. The method of claim 2, wherein causing the modification to the original televised event comprises adding a product placement advertisement to the original televised event.

4. The method of claim 3, wherein causing the modification to the original televised event comprises adding one or more markers to the original televised event to draw attention to the product placement advertisement.

5. The method of claim 1, wherein determining that the activity has at least partially been performed comprises receiving a notification that the user has interacted with an advertisement during the altered televised event.

6. The method of claim 1, wherein determining that the activity has at least partially been performed comprises receiving a notification that the user has made a purchase during a presentation of the original televised event, wherein the modification of the original televised event is performed during the presentation of the original televised event.

7. The method of claim 6 further comprising dynamically adjusting a cost of the original televised event based on performance of the activity.

8. The method of claim 1, wherein the activity includes a restriction of at least a portion of a user device during at least a portion of the altered televised event.

9. The method of claim 1 further comprising:
identifying a plurality of user profiles that have been registered to view the televised event in a group;
analyzing the plurality of user profiles to identify at least one common advertising attribute; and
selecting an electronic advertisement for presentation during the altered televised event, wherein providing the altered televised event comprises presenting the electronic advertisement during the altered televised event.

10. A non-transitory computer-readable medium having encoded therein programming code executable by a processor to perform or control performance of operations comprising:
providing an option to alter an original televised event in exchange for a performance of an activity, wherein the activity includes two or more activities selected from a group of activities consisting of: paying a fee to alter the original televised event, consuming an advertisement, and making a purchase;
receiving a user selection of the option to alter the original televised event, a user selection of the activity, and an agreement of the user to perform the activity;
causing a modification to the original televised event to create an altered televised event based on the option;
determining that the activity has at least partially been performed; and
providing the altered televised event.

11. The non-transitory computer-readable medium of claim 10, wherein the option to alter the televised event comprises:
an alteration to a set of advertisements associated with the original televised event; or
an alteration of a price associated with the original televised event.

12. The non-transitory computer-readable medium of claim 11, wherein causing the modification to the original televised event comprises adding a product placement advertisement to the original televised event.

13. The non-transitory computer-readable medium of claim 10, wherein determining that the activity has at least partially been performed comprises receiving a notification that the user has interacted with an advertisement during the altered televised event.

14. The non-transitory computer-readable medium of claim 10, wherein determining that the activity has at least partially been performed comprises receiving a notification that the user has made a purchase during a presentation of the original televised event, wherein the modification of the original televised event is performed during the presentation of the original televised event.

15. The non-transitory computer-readable medium of claim 10, wherein the activity includes a restriction of at least a portion of a user device during at least a portion of the altered televised event.

16. The non-transitory computer-readable medium of claim 10, the operations further comprising:
identifying a plurality of user profiles that have been registered to view the televised event in a group;
analyzing the plurality of user profiles to identify at least one common advertising attribute; and
selecting an electronic advertisement for presentation during the altered televised event, wherein providing the altered televised event comprises presenting the electronic advertisement during the altered televised event.

17. A system comprising:
a memory; and
a processing device operatively coupled to the memory, the processing device being configured to, in response to executing instructions stored on the memory, cause the system to:
provide an option to alter an original televised event in exchange for a performance of an activity, wherein the activity includes two or more activities selected from a group of activities consisting of: paying a fee to alter the original televised event, consuming an advertisement, or making a purchase;
receive a user selection of the option to alter the original televised event, a user selection of the activity, and an agreement of the user to perform the activity;
cause a modification to the original televised event to create an altered televised event based on the option;
determine that the activity has at least partially been performed; and
provide the altered televised event.

18. The system of claim 17, wherein when determining that the activity has at least partially been performed, the processing device is further configured to receive a notification that the user has interacted with an advertisement during the altered televised event.

19. The system of claim 17, wherein the processing device is further configured to:
identify a plurality of user profiles that have been registered to view the televised event in a group;
analyze the plurality of user profiles to identify at least one common advertising attribute; and
select an electronic advertisement for presentation during the altered televised event, wherein when providing the altered televised event, the processing device is further configured to present the electronic advertisement during the altered televised event.

20. The system of claim 17, wherein the activity includes a restriction of at least a portion of a user device during at least a portion of the altered televised event.
